(19) United States
(12) Patent Application Publication
(10) Pub. No.: US 2005/0240830 A1
(43) Pub. Date: Oct. 27, 2005

(54) Multiprocessor system, processor device

(75) Inventors: Masahito Kubo, Kawasaki (JP); Takashi Chiba, Kawasaki (JP); Hirofumi Koseki, Kahoku (JP)

Correspondence Address: STAAS & HALSEY LLP, SUITE 700, 1201 NEW YORK AVENUE, N.W., WASHINGTON, DC, 20005, US

(73) Assignees: Fujitsu Limited, Kawasaki (JP); PFU Limited, Ishikawa (JP)

(21) Appl. No.: 10/998,152

(22) Filed: Nov. 29, 2004

(30) Foreign Application Priority Data
Apr. 9, 2004 (JP) 2004-115732

(51) Int. Cl. G06F 11/00

(52) U.S. Cl. 714/45

(57) ABSTRACT

In the initialization of a multiprocessor system, device history information containing mounting position information indicating a mounting position of a CPU board supplied from a history information supplying unit is stored in a nonvolatile storage unit in the CPU board capable of storing plural pieces of device history information, so that the mounting position information on each of CPU boards can be accurately and automatically recorded in each CPU board and the history of the mounting position of the CPU board can be recorded and managed on a CPU board by CPU board basis.

### CROSS-REFERENCE TO RELATED APPLICATIONS

This application is based upon and claims the benefit of priority from the prior Japanese Patent Application No. 2004-115732, filed on Apr. 9, 2004, the entire contents of which are incorporated herein by reference.

### BACKGROUND OF THE INVENTION

1. Field of the Invention

The present invention relates to a multiprocessor system composed of plural processor devices each including a CPU.

2. Description of the Related Art

Generally, when some failure occurs in a computer system, a faulty section is identified in units of replacement (for example, on a board-by-board basis) by investigating the failure, and by replacing the identified faulty section with a normally operating one, a restoration work of a system failure is performed. The identified faulty section is subjected to failure analysis by a reproduction test and the like of the failure after replacement, and a fault location is identified to a part level. Then, a faulty part is replaced with a non-defective. After undergoing the aforementioned process, the faulty section demounted from the system in which the failure has occurred is reused as a non-defective after the faulty part which is the cause of the failure is replaced and then a normal operation is confirmed.

The computer system is shipped and brought into operation after operations are checked by a predetermined shipping test, whereby the frequency of occurrence of a failure in the system after the system is brought into operation is generally low. However, the identification of the cause of a failure when the failure occurs after the system is brought into operation often requires considerable labor and time and is difficult when the system does not have RAS (Reliability, Availability, Serviceability) function including advanced error detection, error correction, error log recording, and so on.

Some general information retrieval systems using a record medium store the update history of stored data in a retrieval table of the record medium or a retrieval table of a computer system (for example, see Patent Document 1).

(Patent Document 1)

Japanese Patent Application Laid-open No. Hei 6-325095

At present, many general-purpose microprocessors do not have RAS function. Hence, in a system equipped with a microprocessor as a CPU, it is very difficult to identify the cause of a failure, and even if a faulty section can be identified, the failure sometimes cannot be reproduced in a reproduction test using the demounted faulty section. Moreover, it is one of reasons why the reproduction of the failure is difficult that the reproduction test and failure analysis can seldom be executed under an environment exactly equal to an actual system operating environment when the failure occurred.

Here is a multiprocessor system composed of many CPU boards, each CPU board equipped with a microprocessor as a CPU and being insertable into a slot (mounting portion) provided in a case. In such a large-scale multiprocessor system equipped with many microprocessors (CPU boards), it is more difficult to identify the fault location.

This is because with an increase in the size of the system, variations in cooling capacity occur according to positions inside the case, and because with an increase in the size of a carrier board, the wiring state is changed, which causes mounting position dependence. Accordingly, in some cases, the failure is not reproduced if the installation environment including an ambient temperature of the system is different, and the failure is not reproduced if the faulty section brought back is mounted in a mounting position different from its corresponding mounting position.

When the failure is not reproduced, an article brought back as the faulty section is judged to be a non-defective and reused, which raises the possibility of reproduction of the failure after reuse.

Moreover, when the failure repeatedly occurs only in a specific mounting position of the system, it is supposed that the cause of the failure does not exist in the article brought back as the faulty section but exists in the system itself.

To solve the aforementioned problems, it is important to trace information on the replacement history of CPU boards, but if the replacement history is inaccurate, for example, due to the taking in and out (replacement) of the CPU boards by a user, the tracing exerts a bad influence on failure analysis and creates confusion.

### SUMMARY OF THE INVENTION

An object of the present invention is to make it possible to accurately and automatically record information on the replacement history of CPU boards in a multiprocessor system.

A multiprocessor system of the present invention comprises: a history information supplying unit which supplies device history information to a processor device in the initialization of the system; and a nonvolatile and rewritable storage unit which is included in each of the processor devices and stores the device history information. The device history information contains mounting position information indicating a position where the processor device is mounted in the multiprocessor system.

According to the aforementioned configuration, plural pieces of mounting position information on each of the processor devices in the multiprocessor system supplied when the system is initialized can be accurately and automatically recorded in each of the processor devices.

Further, it is also possible to compare the mounting position information of the device history information supplied from the history information supplying unit and mounting position information of up-to-date device history information already stored in the storage unit and, when these two pieces of mounting position information are different as a result of the comparison, store the supplied device history information in the storage unit. In this case, only when the mounting position information is different from the mounting position information of the up-to-date device history information stored in the storage unit, that is, only when the mounting position has changed, the supplied device history information is stored in the storage unit, so that the device history information can be efficiently stored in the storage unit, which makes it possible to reduce the storage capacity required for the storage unit.

### BRIEF DESCRIPTION OF THE DRAWINGS

FIG. 1 is a block diagram showing a system configuration example of a multiprocessor system according to an embodiment of the present invention;

FIG. 2 is a block diagram showing a configuration example of a CPU in the embodiment;

FIG. 3 is a block diagram showing a functional configuration of a CPU board in the embodiment;

FIG. 4A is a diagram showing an example of a record format of device history information in the embodiment;

FIG. 4B is a diagram showing an example of device-specific information recording area in a ROM;

FIG. 5 is a flowchart showing an example of an activation process of the multiprocessor system according to the embodiment;

FIG. 6 is a flowchart showing an example of a mounting position history updating process; and

FIG. 7 is a diagram showing another configuration example of the multiprocessor system according to the embodiment of the present invention.

### DETAILED DESCRIPTION OF THE PREFERRED EMBODIMENTS

An embodiment of the present invention will be described below based on the drawings.

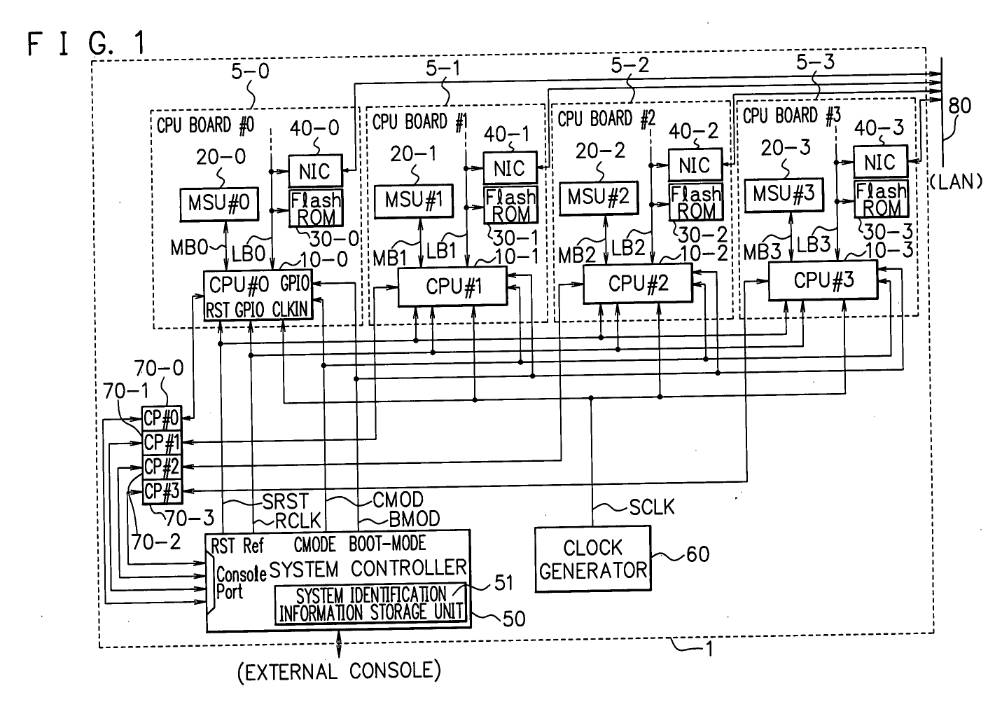

FIG. 1 is a block diagram showing a system configuration example of a multiprocessor system 1 according to an embodiment of the present invention.

The multiprocessor system 1 includes CPUs 10-i being central processing units, MSUs 20-i being main storage units, flash memories (Flash-ROMs, each hereinafter called a “ROM”) 30-i, network interfaces (NICs: Network Interface Cards) 40-i, a system controller 50, a clock generator 60, and console ports (CPs: Console-Ports) 70-i. Incidentally, i is a subscript and i is an integer between 0 and 3 in the example shown in FIG. 1 (the same applies to the following description).

The CPUs 10-i fetch, decode, and execute instructions composing a program. Namely, each of the CPUs 10-i controls the MSU 20-i, the ROM 30-i, the NIC 40-i, and so on connected thereto by reading and executing the program.

The MSU 20-i is connected to each CPU 10-i via a memory bus (memory interface) MBi, and the ROM 30-i, the NIC 40-i, and so on are connected to each CPU 10-i via a local bus LBi. More specifically, an MSU 20-0 is connected to a CPU 10-0 via a memory bus MBO, and a ROM 30-0, an NIC 40-0, and so on are connected to the CPU 10-0 via a local bus LBO. Similarly, to CPUs 10-1 to 10-3, their corresponding MSUs 20-1 to 20-3, ROMs 30-1 to 30-3, NICs 40-1 to 40-3, and so on are connected.

As shown in FIG. 1, one CPU board 5-i is composed of a set of the CPU 10-i, the MSU 20-i, the ROM 30-i, the NIC 40-i, and so on. Each of the CPU boards 5-i, as a unit, is insertable into a slot (mounting portion) provided in a case of the multiprocessor system 1, that is, it is replaceable.

Each of the CPUs 10-i (each CPU board 5-i) is connected to the console port 70-i.

To each of the CPUs 10-i, a reset signal (system reset signal) SRST, a clock reference signal RCLK, a clock mode signal CMOD, and a boot mode signal BMOD are supplied from the system controller 50 and a clock source (clock input signal) SCLK is supplied from the clock generator 60. The reset signal SRST is inputted from a reset input <RST>, the clock source SCLK is inputted from a clock input <CLKIN>. The clock reference signal RCLK, the clock mode signal CMOD, and the boot mode signal BMOD are inputted from different general-purpose input/output <GPIOs: General Purpose I/Os>, respectively. Incidentally, each of the signals will be described later in detail.

The MSU 20-i is composed of a memory (for example, a RAM such as a SDRAM) or the like and temporarily stores a program such as an OS (operating system), data, and the like. The MSU 20-i is used when the CPU 10-i performs various kinds of controls, and functions as a so-called main memory, a work area, or the like of the CPU 10-i.

In the ROM 30-i, board information on the CPU board 5-i which includes the ROM 30-i itself and device history information containing mounting position information indicating a slot (mounting position) where mounting is performed in the multiprocessor system 1 are stored. Moreover, in the ROM 30-i, a program (a boot program or a boot program and an OS) executed by the CPU 10-i, data, and so on are stored. Incidentally, in this embodiment, the flash memory is shown as an example of the ROM 30-i, but the ROM 30-i is not limited to this example, and it is only required to be a rewritable nonvolatile memory.

The NIC 40-i is a communication interface to transmit and receive data and so on between the CPU 10-i and external equipment via a network (a LAN 80 in FIG. 1). Incidentally, in this embodiment, the LAN 80 is shown as an example of the network, but the network is not limited to this example, and any network which is generally used is applicable.

The system controller 50 controls the entire multiprocessor system 1 and includes a system identification information storage unit 51. The system controller 50 outputs the reset signal SRST, the clock reference signal RCLK, the clock mode signal CMOD, and the boot mode signal BMOD.

The system controller 50 is connected so as to be communicatable with the CPUs 10-i via the respective console ports 70-i, and supplies device history information to each of the CPU boards 5-i at the time of initialization of the system. The system controller 50 is also connected so as to be communicatable with an external console which an operator or the like can operate.

The system identification information storage unit 51 is composed of a nonvolatile storage device (nonvolatile memory), and holds system identification information given to the multiprocessor system 1 (for example, a unique serial number by which the system can be uniquely identified). The system identification information held by the system identification information storage unit 51 is supplied to each of the CPU boards 5-i via the console port 70-i as required at the time of initialization of the multiprocessor system 1.

The clock generator 60 generates and outputs the clock source SCLK. The frequency of the clock source SCLK generated and outputted by the clock generator 60 can be optionally changed by controlling the clock generator 60.

The console port 70-i is an input/output interface to transmit/receive data and so on between the CPU 10-i and the system controller 50. The console port 70-i, for example, transmits the device history information and system identification information concerned with the CPU board 5-i from the system controller 50 to the CPU 10-i at the time of initialization of the system. Moreover, the console port 70-i, for example, transmits a message from the OS which is operating in the CPU 10-i to the system controller 50 to deliver the message to the operator, and transmits a command from the system controller 50 to the CPU 10-i.

Here is an explanation of the reset signal SRST, the clock reference signal RCLK, the clock mode signal CMOD, the boot mode signal BMOD, and the clock source SCLK.

The reset signal SRST is a hardware reset signal to initialize each of the CPUs 10-i composing the multiprocessor system 1.

The clock source SCLK is a clock signal supplied to the CPUs 10-i as an operation clock signal.

The clock reference signal RCLK is a reference signal with a fixed frequency and a fixed duty ratio (clock duty) for clock adjustment, and is a signal of relatively lower frequency than the clock source SCLK. For example, the frequency of the clock reference signal RCLK is 1 MHz, whereas the frequency of the clock source SCLK is between 37 MHz and 66 MHz. Incidentally, information on the clock reference signal RCLK is appropriately supplied to the CPUs 10-i and held therein.

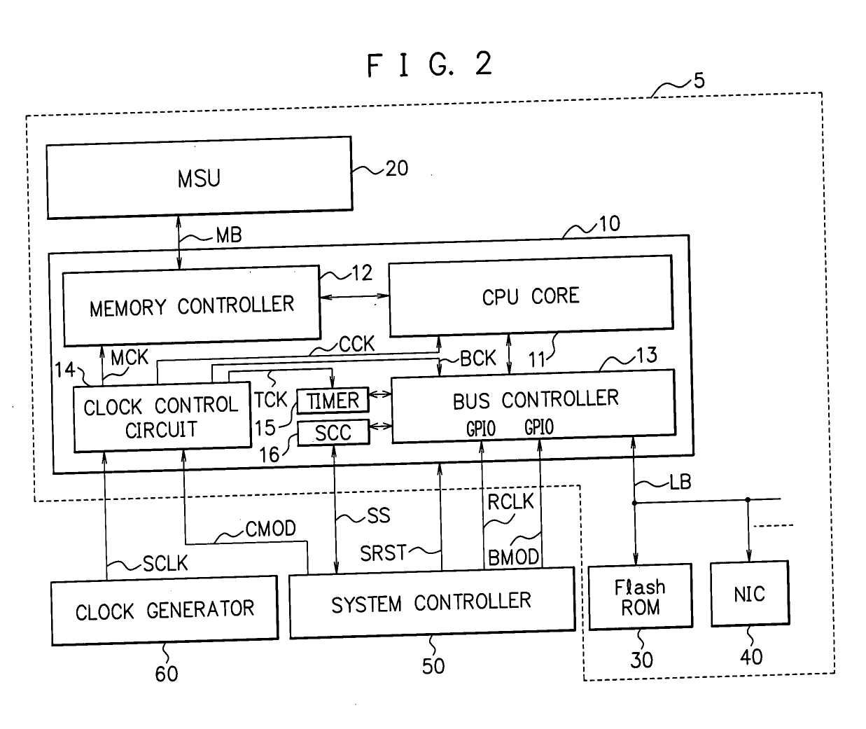

The clock mode signal CMOD is a signal showing the relation between frequencies of an operation clock of the CPU and control clocks of various interfaces to perform clock adjustment in the multiprocessor system 1, and in more detail, the ratio of clock frequencies of a CPU core, a memory bus (memory), and a local bus shown in FIG. 2. According to the value shown by the clock mode signal CMOD, the relation between frequencies of the operation clock of the CPU and the control clocks of the various interfaces is uniquely determined.

The boot mode signal BMOD is a signal to indicate a boot sequence.

Incidentally, the multiprocessor system composed of four CPU boards 5-0 to 5-3 is shown as an example in FIG. 1, but the number of CPU boards included in the multiprocessor system is optional.

FIG. 2 is a block diagram showing a configuration example of the CPU 10-i.

Incidentally, configurations of the respective CPUs 10-i are the same, and hence only one CPU is shown in FIG. 2. Accordingly, the subscript i added to the numerals in FIG. 1 is not added. Moreover, the same numerals and symbols are used to designate blocks and the like having the same functions as those in FIG. 1, and a repeated explanation is omitted.

A CPU 10 includes a CPU core 11, a memory controller 12, a bus controller 13, a clock control circuit 14, a timer 15, and an SCC (Serial Communication Controller) 16.

The CPU core 11 executes a computation, manipulation and the like on data in the CPU 10.

The memory controller 12 is connected to an MSU 20 via a memory bus MB and controls the MSU 20 based on an instruction from the CPU core 11. Namely, the memory controller 12 writes data to the MSU 20 or reads data from the MSU 20.according to the instruction from the CPU core 11.

The bus controller 13 controls peripheral devices connected-to a local bus LB based on an instruction from the CPU core 11. The bus controller 13 is connected to the timer 15 and the SCC 16. The clock reference signal RCLK and the boot mode signal BMOD are supplied to the bus controller 13 from the system controller 50.

The clock control circuit 14 includes a multiplication circuit and a PLL (Phase Locked Loop) circuit. Referring to the clock mode signal CMOD, the clock control circuit 14 generates respective clock signals CCK, MCK, BCK, and TCK in a frequency ratio according to the value shown by the clock mode signal CMOD using the clock source SCLK. The clock control circuit 14 then supplies the generated clock signals CCK, MCK, BCK, and TCK to the CPU core 11, the memory controller 12, the bus controller 13, and the timer 15, respectively. Incidentally, in FIG. 2, the clock signals BCK and TCK supplied to the bus controller 13 and the timer 15 are different clock signals, but clock signals supplied to the bus controller 13 and the timer 15 may be the same clock signal.

The timer 15 performs a time keeping operation based on the supplied clock signal TCK.

The SCC 16 is a controller to serially transmit data between the CPU 10 and the system controller 50 via a console port 70.

Next, a functional configuration of a CPU board 5 will be explained.

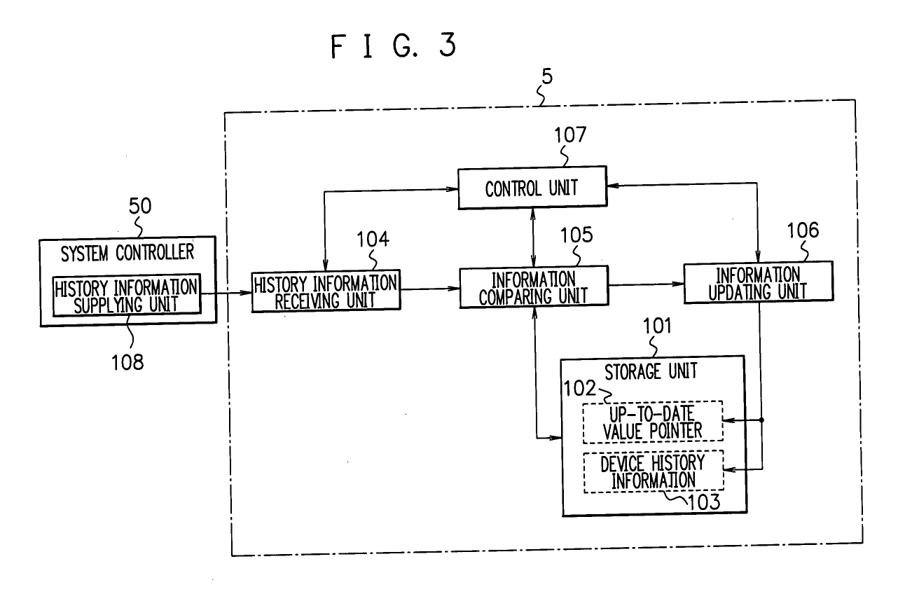

FIG. 3 is a block diagram showing the functional configuration of the CPU board 5, and here only an elemental characteristic is shown.

In this embodiment, function units 104, 105, 106, and 107 are configured by the CPU 10 and boot programs of the ROM 30, and a storage unit 101 is configured by the ROM 30.

In FIG. 3, the storage unit 101 is to store device history information on the CPU board 5 and stores an up-to-date value pointer 102 and device history information 103. The up-to-date value pointer 102 manages the storage order of the device history information 103 stored in the storage unit 101, and indicates the storage position of up-to-date device history information. Namely, the up-to-date device history information is stored in an address in the storage unit 101 indicated by the up-to-date value pointer 102.

The history information receiving unit 104 receives device history information on the CPU board 5 supplied from a history information supplying unit 108 in the system controller 50 and outputs it to the information comparing unit 105. This received device history information contains mounting position information indicating a slot (mounting position) where the CPU board 5 is mounted in the multiprocessor system 1 as described above.

The information comparing unit 105 compares the device history information supplied from the history information receiving unit 104 and the up-to-date device history information already stored in the storage unit 101, and notifies the information updating unit 106 of a result of the comparison. More specifically, the information comparing unit 105 refers to the up-to-date value pointer 102 stored in the storage unit 101 and reads the up-to-date device history information from the address indicated by the up-to-date value pointer 102. The information comparing unit 105 then determines by comparison whether the mounting position information in the device history information supplied from the history information receiving unit 104 and mounting position information in the up-to-date device history information read from the storage unit 101 coincide and notifies a result of the determination to the information updating unit 106.

When the information comparing unit 105 determines that these two pieces of mounting position information of the two pieces of device history information are different, the information updating unit 106 stores the device history information received by the history information receiving unit 104 in the storage unit 101 and updates the up-to-date value pointer 102.

Note that the history information receiving unit 104, the information comparing unit 105, and the information updating unit 106 are respectively controlled by the control unit 107.

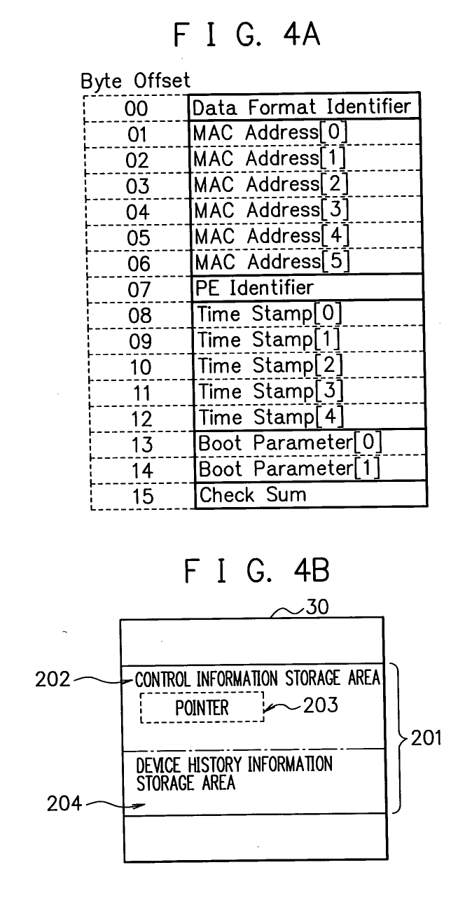

Next, the ROM 30 in this embodiment will be explained with reference to FIG. 4A and FIG. 4B. Incidentally, the ROM 30 stores board information, device history information, programs, data, and so on, but in FIG. 4A and FIG. 4B, areas in which the programs and the data are stored are not clearly specified.

FIG. 4A is a diagram showing an example of a record format of device history information containing mounting position information, and FIG. 4B is a diagram showing an example of device-specific information recording area in the ROM.

As shown in FIG. 4A, one piece of device history information is data with a 16-byte length as shown by byte offset values 00 to 15.

A data format identifier is recorded in a 1-byte field corresponding to the byte offset value 00.

A MAC address as the mounting position information is stored in a 7-byte field corresponding to the byte offset values 01 to 07. In this embodiment, a MAC address format is a combination of a MAC address base part (MAC address [0] to MAC address [5]) composed of 6-byte data and an identifier (PE identifier) composed of 1-byte data. The identifier (PE identifier) has values from 0 to 127, and the mounting position of the CPU board 5 in the multiprocessor system 1 can be uniquely identified by the value of the identifier (PE identifier). In other words, the value of the identifier (PE identifier) and each of the slots which are connectable with the CPU boards provided in the multiprocessor system 1 have a one-to-one correspondence. Incidentally, in the example shown in FIG. 4A, the values which the identifier (PE identifier) can take on is from 0 to 127, that is, the number of slots is 128 or less, but if the number of slots is 129 or more, data on the identifier (PE identifier) may be expanded by appropriately changing the data length of the device history information, or the like.

In a 5-byte field corresponding to the byte offset values 08 to 12, time information indicating the time when the device history information is supplied is recorded. Note that the time information may be time information indicating the time when the device history information is written into the ROM 30.

In a 2-byte field corresponding to the byte offset values 13 to 14, boot parameters are recorded, and in a 1-byte field corresponding to the byte offset value 15, a chuck sum to perform error detection on data on the device history information is recorded.

Incidentally, in the example of the record format shown in FIG. 4A, any field for recording system identification information is not provided, but it is also possible to receive the system identification information as well as the mounting position information and so on from the system controller 50 and provide a record field for the system identification information so as to record the device history information containing the system identification information.

The ROM 30 is provided with a storage area as shown in FIG. 4B, and the device history information is stored in a device-specific information storage area 201. This device-specific information-storage area 201 can be changed appropriately according to the data capacity of the ROM 30 and a rewrite unit in the ROM 30, and it is composed of two areas: a control information storage area 202 and a device history information storage area 204. Note that a first address of the device-specific information storage area 201 is fixed.

In the control information storage area 202, a device serial number given to the CPU board 5, storage capacity information on the MSU 20, pointers of various areas, and area sizes of the various areas are stored. In the device history information storage area 204, the device history information containing the mounting position information and the time information which is configured according to the record format shown in FIG. 4A is stored.

The device history information storage area 204 here has an area size capable of storing plural pieces of device history information, the plural pieces of device history information are stored in sequence in such a manner as to add a postscript, and an up-to-date value pointer 203 to manage the device history information and an area size are stored in an fixed address in the control information storage area 202. Namely, an up-to-date value of the device history information is stored in an address indicated by the up-to-date value pointer 203 stored in the control information storage area 202, and by referring to the up-to-date value pointer 203, the up-to-date device history information can be easily acquired.

Next, the operation of the multiprocessor system 1 according to this embodiment will be explained.

Incidentally, in the following explanation, only an activation process from when the reset signal SRST is outputted from the system controller 50 in response to power-on or an instruction from the outside until the operation by the OS is started will be explained, and an explanation of other operations is omitted since they are the same as those of a conventional multiprocessor system.

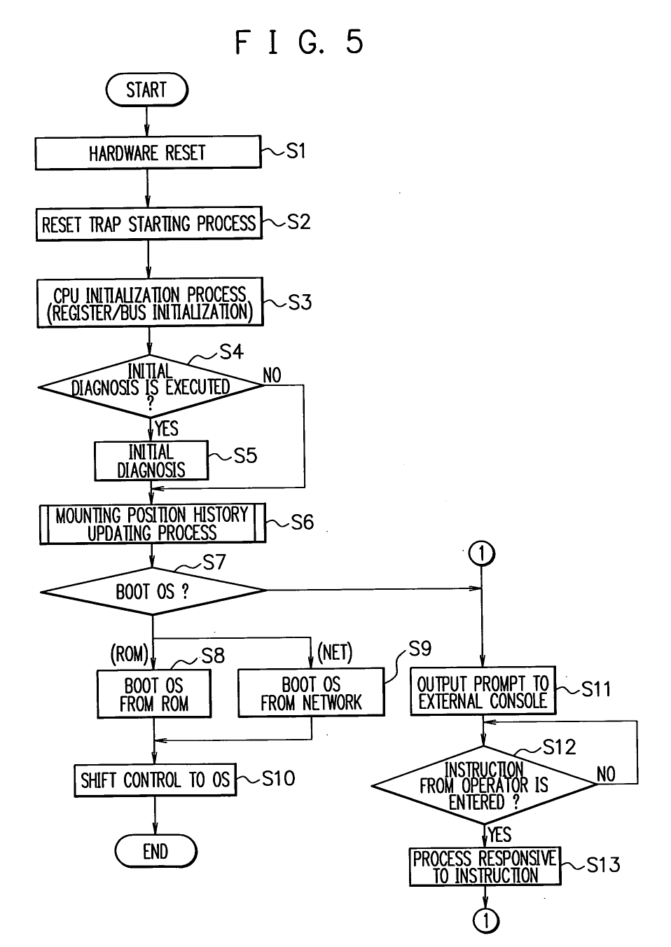

FIG. 5 is a flowchart showing an example of the activation process of the multiprocessor system 1 according to this embodiment.

First, the system controller 50 outputs the reset signal SRST to each of the CPUs 10. Each CPU 10 which has received the reset signal SRST executes a hardware reset to initialize internal registers and the like in step S1.

In step S2, each CPU 10 automatically generates a reset trap at the completion of the hardware reset to perform a reset trap starting process. More specifically, each CPU 10 sets a prescribed value in a program status word and simultaneously sets a reset trap execution starting address (Reset Vector) in a program counter. Here, a boot program for system boot is stored from a first address of the ROM 30, and the first address of the ROM 30 is set as the reset trap execution starting address.

In step S3, each CPU 10 starts the execution of the boot program. First, each CPU 10 initializes general-purpose registers and other control registers (including the timer 15) included therein as a preparation for subsequent program execution, and performs initialization of buses including address setting of peripheral devices. After the resisters and buses are initialized, the CPU 10 performs clock adjustment of the wait number (wait time) concerned with devices connected to the buses based on the supplied clock reference signal RCLK, clock source SCLK, and clock mode signal CMOD.

In step S4, each CPU 10 determines whether to execute an initial diagnosis with reference to the supplied boot mode signal BMOD. When the execution of the initial diagnosis is designated by the boot mode signal BMOD as a result of the determination, the initial diagnosis of the CPU 10, the MSU 20, and so on is executed in step S5, and the CPU 10 goes to step S6. On the other hand, when the execution of the initial diagnosis is not designated by the boot mode signal BMOD, the CPU 10 skips step S5 and goes to step S6.

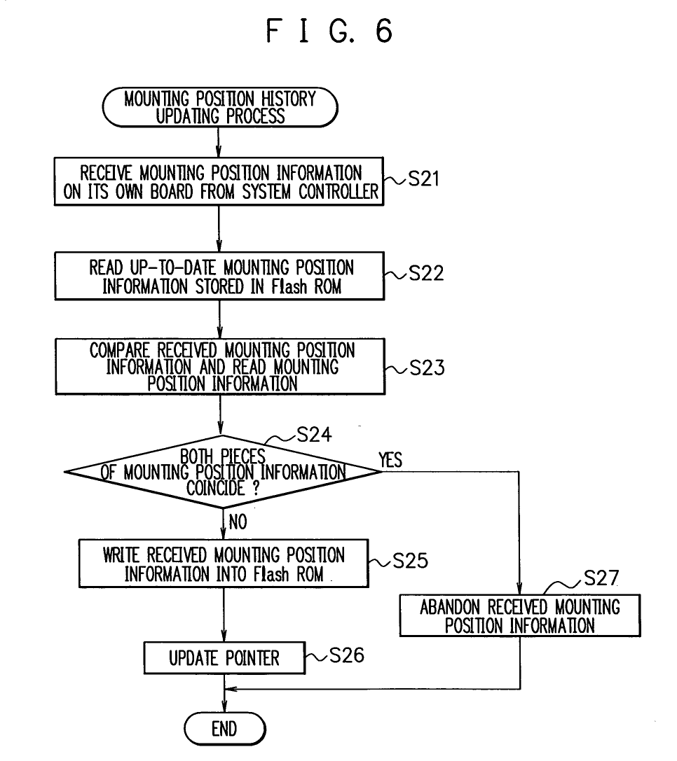

In step S6, each CPU 10 performs a mounting position history updating process shown in FIG. 6.

FIG. 6 is a flowchart showing an example of the mounting position history updating process.

First, in step S21, the CPU 10 receives mounting position information (device history information) on the CPU board 5, which is configured including the CPU 10 itself, from the system controller 50.

In step S22, the CPU 10 reads up-to-date mounting position information out of mounting position information already stored in the ROM 30 from the ROM 30. More specifically, the CPU 10 refers to the up-to-date value pointer 203 stored in the control information storage area 202 of the ROM 30. Then, the CPU 10 reads device history information from an address indicated by the up-to-date value pointer 203 and extracts mounting position information contained in the device history information.

In step S23, the CPU 10 compares the mounting position information received in step S21 and the mounting position information read in step S22. Subsequently, in step S24, the CPU 10 determines whether these two pieces of mounting position information coincide.

When the mounting position information received in step S21 and the mounting position information read in step S22 are different as a result of the determination, the CPU 10 writes the mounting position information received in step S21 into the device history information storage area 204 of the ROM 30 in step S25. Thereby, device history information containing up-to-date mounting position information is additionally recorded in the ROM 30.

Then, in step S26, the CPU 10 updates the value of the up-to-date value pointer 203 so that an address into which the device history information is written in step S25 is indicated.

On the other hand, when the mounting position information received in step S21 and the mounting position information read in step S22 coincide as a result of the determination in step S24, in step S27, the CPU 10 abandons the mounting information received in step S21. Accordingly, the device history information recorded in the device history information storage area 204 of the ROM 30 is not updated.

After the mounting position history updating process is completed in the manner described above, the CPU 10 returns to step S7 in FIG. 5.

Returning to FIG. 5, in step S7, with reference to the boot mode signal BMOD, each CPU 10 determines whether to boot the OS from the ROM 30, boot the OS via the LAN 80 (network), or stop the OS without booting it.

When the booting of the OS from the ROM 30 is designated by the boot mode signal BMOD as a result of the determination, in step S8, the CPU 10 loads and boots the OS from the ROM 30, and goes-to step S10. Similarly, when the booting of the OS via the LAN 80 is designated by the boot mode signal BMOD, in step S9, the CPU 10 loads and boots the OS from external equipment via the LAN 80, and goes to step S10.

In step S10, the CPU 10 shifts control to the booted OS to start an operation by the OS, and the activation process is completed.

When a stop is designated by the boot mode signal BMOD as a result of the determination in step S7, in step S11, the CPU 10 outputs a prompt to the external console via the console port 70 and the system controller 50.

Then, in step S12, the CPU 10 stands by until an instruction, that is, a command from the operator is entered via the external console. When the command entered via the external console is supplied via the system controller 50 and the console port 70, the CPU 10 executes a process responsive to the supplied command in step S13. When this process is completed, the CPU 10 returns to step S11 and repeats the process in steps S11 to S13. Incidentally, when the booting of the OS is designated by the supplied command in the process in steps S11 to S13, the CPU 10 may load and boot the OS in response to the command and go to step S10.

As described above, according to this embodiment, in the initialization of the multiprocessor system, device history information containing mounting position information on the CPU board 5 supplied from the system controller 50 (which may further contain time information and system identification information) is received, the mounting position information of the received device history information and mounting position information of up-to-date device history information already stored in the ROM 30 are compared, and when these two pieces of information are different, the received device history information is additionally stored as up-to-date device history information in the ROM 30.

Consequently, the mounting position of the CPU board 5 can be accurately and automatically recorded in the ROM 30 in the CPU board 5 continuously, and the history of the mounting position of the CPU board 5 in the multiprocessor system 1 can be recorded and managed. Accordingly, if a failure occurs in the multiprocessor system 1, mounting position dependence and processor device dependence which are causes of the failure can be easily analyzed and detected, which-makes it possible to reduce the cost needed to analyze the causes of the failure.

Moreover, only when the mounting position information of the received device history information and the mounting position information of the up-to-date device history information already stored in the ROM 30 are different, the received device history information is stored in the ROM 30, which increases the efficiency of information storage and reduces storage capacity required for the ROM 30, whereby the history of the mounting position of the CPU board 5 can be recorded and managed with a small storage capacity.

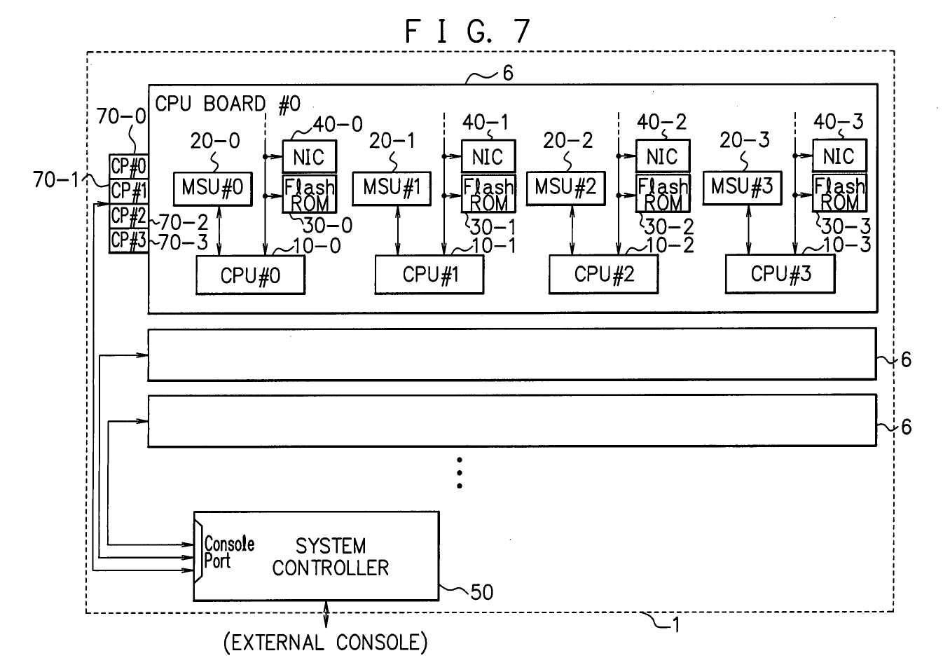

Incidentally, in the aforementioned embodiment, the multiprocessor system 1 composed of the CPU boards 5 each having one CPU 10 is shown as an example, but the present invention is not limited to this example. For example, as shown in FIG. 7, each of CPU boards 6 composing the multiprocessor system 1 may include plural CPUs 10. In such a configuration, the device history information supplied from the system controller 50 may be stored, for example, in the ROM 30 corresponding to at least one CPU 10 which is previously determined (for example, the ROM 30-0 connected to the CPU 10-0), or in all of the ROMs 30 in the CPU board 6.

The present embodiment is to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

According to the present invention, plural mounting positions of each of processor devices in a multiprocessor system can be accurately and automatically recorded in each of the processor devices, and the history of the mounting position of the processor device can be recorded and managed on a processor device by processor device basis. Consequently, when a failure occurs in the system, mounting position dependence and processor device dependence which are causes of the failure can be analyzed and detected even if the failure occurs intermittently or the failure is not reproduced, which makes it possible to reduce the cost needed to analyze the causes of the failure.

1. A multiprocessor system composed of plural replaceable processor devices, comprising:
a history information supplying unit supplying device history information containing mounting position information indicating a position where the processor device is mounted in the multiprocessor system to the processor device in initialization of the multiprocessor system; and
a nonvolatile and rewritable storage unit being included in each of the processor devices and storing the device history information supplied from said history information supplying unit,
said storage unit being allowed to store plural pieces of the device history information.

2. The multiprocessor system according to claim 1, further comprising:
a comparison unit comparing the mounting position information of the device history information supplied from said history information supplying unit and the mounting position information of up-to-date device history information stored in said storage unit, wherein
when these two pieces of mounting position information are different as a result of the comparison by said comparison unit, the device history information supplied from said history information supplying unit is stored in said storage unit.

3. The multiprocessor system according to claim 1, further comprising:
a management unit managing storage order of device history information stored in said storage unit.

4. The multiprocessor system according to claim 3, wherein said management unit is a pointer pointing to a storage position of the device history information being up-to-date in said storage unit.

5. The multiprocessor system according to claim 1, wherein the device history information contains time information when the device history information is supplied.

6. The multiprocessor system according to claim 1, wherein said device history information contains system identification information allowing the multiprocessor system to be uniquely identified.

7. The multiprocessor system according to claim 1, wherein the processor device includes plural processors.

8. A processor device being allowed to be mounted in a multiprocessor system composed of plural replaceable processor devices, comprising:
a history information receiving unit receiving device history information containing mounting position information indicating a position in the multiprocessor system where the processor device is mounted;
a storage unit being allowed to store plural pieces of the device history information and being nonvolatile and rewritable;
a comparison unit comparing the mounting position information of the device history information received by said history information receiving unit and the mounting position information of up-to-date device history information stored in said storage unit, wherein
when these two pieces of mounting position information are different as a result of the comparison by said comparison unit, the device history information received by said history information receiving unit is stored in said storage unit.

9. The processor device according to claim 8, further comprising:
a management unit managing storage order of the device history information.

10. The processor device according to claim 8, wherein said processor device includes plural processors.
